(19) United States
(12) Patent Application Publication
(10) Pub. No.: US 2002/0141671 A1
(43) Pub. Date: Oct. 3, 2002

(54) Thin self-lubricating film/metallic bearing system and a method for implementing same

(76) Inventors: Glenwood H. Narkon, Ellington, CT (US); Mathew Mormino JR., Windsor Locks, CT (US)

Correspondence Address: Cantor Colburn LLP, 55 Griffin Road South, Bloomfield, CT, 06002, US

(21) Appl. No.: 10/109,440

(22) Filed: Mar. 27, 2002

Related U.S. Application Data
(60) Provisional application No. 60/279,176, filed on Mar. 27, 2001.

(51) Int. Cl. F16C 33/10

(52) U.S. Cl. 384/322

(57) ABSTRACT

A thin self-lubricating film bearing system including a mating structure having a mating surface, a substrate, wherein the substrate includes a substrate surface having a plurality of valleys, wherein the substrate is disposed so as to communicate the mating surface with the substrate surface and a lubricating material, wherein the lubricating material is disposed relative to the substrate so as to be communicated with the substrate surface and the mating surface. A method for implementing a self-lubricating film bearing system including obtaining a lubricating material and a substrate, wherein the substrate includes a substrate surface, processing the substrate surface so as to create a plurality of valleys within the substrate surface, cleaning the substrate surface so as to remove impurities from the substrate surface, applying the lubricating material to the substrate surface so as to dispose a thin film of the lubricating material on the substrate surface and associating the substrate with a mating structure having a mating surface, wherein the mating structure is disposed relative to the substrate such that the lubricating material is disposed between the substrate surface and the mating surface.

### CROSS-REFERENCE TO RELATED APPLICATIONS

This application claims the benefit of U.S. provisional application No. 60/279,176, filed Mar. 27, 2001 the contents of which are incorporated by reference herein in their entirety.

### BACKGROUND OF THE INVENTION

This invention relates generally to a self-lubricating bearing system and a method for implementing a self-lubricating bearing system and more particularly to a thin self-lubricating film/metallic bearing system and a method for implementing same.

Most existing bearing system designs utilize a thin dry film lubricant or grease to lubricate bearings used in applications that experience high loads such as static joints, small oscillatory motions or applications that experience high levels of vibration or micro-motion. However, one of the main problems observed with these designs is that the dry film lubricant or grease migrates out of the bearing resulting in fretting, galling, seizure or migration of the bearing in the bearing housing (rotational and/or axial movement). In an attempt to address this problem, bearing system designers have tried to apply self-lubricating PTFE or Teflon® fabrics and/or non-peelable PTFE or Teflon® liner systems. However, these systems do not have adequate load carrying capability and therefore cannot meet the stiffness requirements for these types of bearings.

Therefore, there is a need for a self-lubricating bearing system and a method for implementing the self-lubricating bearing system, wherein the self-lubricating bearing system satisfies desired stiffness and load carrying requirements and wherein the method and system may be implemented in an inexpensive and reliable manner.

### SUMMARY OF THE INVENTION

A thin self-lubricating film bearing system comprising: a mating structure having a mating surface; a substrate, wherein the substrate includes a substrate surface having a plurality of valleys, wherein the substrate is disposed so as to communicate the mating surface with the substrate surface; and a lubricating material, wherein the lubricating material is disposed relative to the substrate so as to be communicated with the substrate surface and the mating surface.

A method for implementing a self-lubricating film bearing system comprising: obtaining a lubricating material and a substrate, wherein the substrate includes a substrate surface; processing the substrate surface so as to create a plurality of valleys within the substrate surface; cleaning the substrate surface so as to remove impurities from the substrate surface; applying the lubricating material to the substrate surface so as to dispose a thin film of the lubricating material on the substrate surface; and associating the substrate with a mating structure having a mating surface, wherein the mating structure is disposed relative to the substrate such that the lubricating material is disposed between the substrate surface and the mating surface.

### BRIEF DESCRIPTION OF THE DRAWINGS

The above discussed and other features and advantages will be appreciated and understood by those skilled in the art from the following detailed description and drawings, wherein like elements are designated by like numerals in the several figures.

Referring now to the drawings:

FIG. 1 is a cross-sectional side view of a substrate communicated with a mating surface, showing self-lubricating reservoirs in accordance with an exemplary embodiment; and

FIG. 2 is a flow diagram describing a method for implementing a self-lubricating bearing system in accordance with an exemplary embodiment.

### DESCRIPTION OF A PREFERRED EMBODIMENT

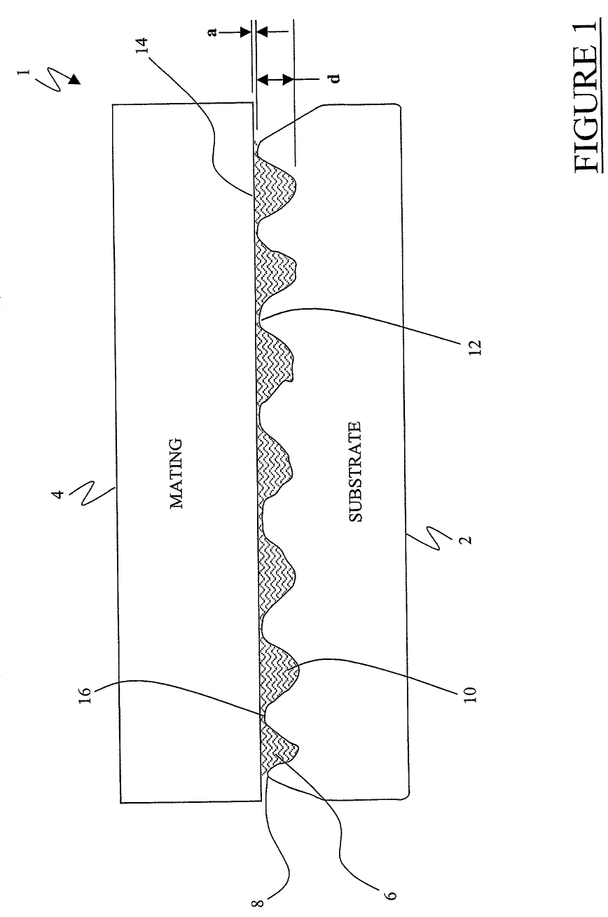

Referring to FIG. 1, a thin self-lubricating film/metallic bearing system 1 is shown and described. In accordance with an exemplary embodiment a self-lubricating bearing system 1 is illustrated and preferably includes a substrate 2, a mating structure 4 and a lubricating material 6. Substrate 2 preferably includes a substrate surface 8 having a plurality of plateaus 12 and a plurality of valleys 10, wherein each valley 10 includes a valley depth d. Mating structure 4 includes a mating surface 14, wherein mating surface 14 is preferably a hard, smooth metallic surface. In accordance with an exemplary embodiment, mating structure 4 is preferably a chrome plated metallic surface. However, mating structure 4 may be constructed of a hardened corrosion resistant and/or stainless steel and/or metallic substrate that has been chrome plated, plasma sprayed and/or HVOF coated. In addition, mating structure 4 may be constructed of any material or combination of materials suitable to the desired end purpose. In accordance with an exemplary embodiment, mating structure 4 may be any hard, smooth metallic surface suitable to the desired end purpose, such as a shaft in a bushing product or against a ball in a spherical bearing product.

In accordance with an exemplary embodiment, substrate 2 is preferably constructed of a copper, nickel and/or tin material. However, substrate 2 may be constructed from any material suitable to the desired end purpose.

In accordance with an exemplary embodiment, lubricating material 6 is preferably constructed from polymer (polyester) resin, lubricant particles such as Teflon® and/or graphite. In accordance with an exemplary embodiment, lubricating material 6 (resin system) may be an epoxy, polyimide, urethane, phenolic or any other lubricating material 6 suitable to the desired end purpose. Moreover, lubricating material 6 preferably includes Teflon(and/or PTFE particles and/or fibers. These particles and/or fibers are preferably sold particles that are mixed with a liquid polymer resin that form a liquefied slurry mixture that turns into a homogenous solid material when the slurry mixture is cured (baked) during the fabrication process. Furthermore, lubricating material 6 is preferably constructed from several types of resins so as to advantageously provide operational capability for thermal environments from about −200° F. to about +700° F.

Lubricating material 6 is preferably disposed relative to substrate surface 8 so as to form a thin film 16 having a thickness a, coating the surface area of substrate surface 8. In addition, lubricant material 6 is also preferably disposed relative to substrate surface 8 so as to be disposed within plurality of valleys 10. In accordance with an exemplary embodiment thickness a, of thin film 16 is preferably about 0.001 to about 0.005 inches thick.

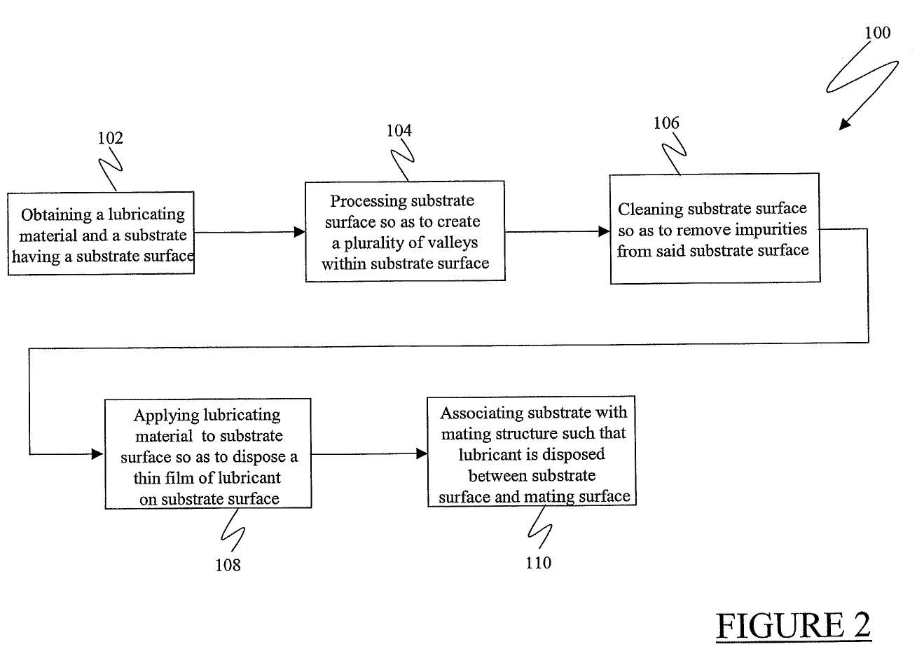

Referring to FIG. 2, a method for implementing a thin self-lubricating film/metallic bearing system 100 is shown and described. In accordance with an exemplary embodiment, a lubricating material 6 and a substrate 2 having a substrate surface 8 is obtained as shown in step 102. In addition a mating structure 4 having a mating surface 14 is also obtained. Substrate surface 8 is then processed so as to create a plurality of valleys 10 as shown in step 104. In accordance with an exemplary embodiment, substrate surface 8 is preferably processed by mechanically roughening substrate surface 8 via abrasive grit blast, controlled peening, a mechanical knurling process, drilling, machining and/or via any method and/or device suitable to the desired end purpose, such as chemical techniques (e.g., etching) or other mechanical techniques.

In accordance with an exemplary embodiment, substrate 2 is preferably constructed using a metal and/or a combination of metals that are corrosion resistant and that are selected for their resistance to galling and/or fretting while in contact with mating surface 14. However, substrate 2 may be constructed using any material suitable to the desired end purpose, such as beryllium copper, aluminum nickel bronze, copper nickel tin (per UNS C72900 and C96900), copper, brass, and spinoidal bronze, stainless steels, and plasma sprayed/high velocity oxy fuel (HVOF) materials.

Once substrate surface 8 is processed, substrate surface 8 is then chemically cleaned so as to remove any impurities as shown in step 106. In accordance with an exemplary embodiment, substrate surface 8 is preferably cleaned using a chemical etchant. However, substrate surface 8 may be cleaned using any alkaline cleaning solution and/or any solvent, method and/or device suitable to the desired end purpose. Lubricating material 6 is then applied to substrate 2 as shown in step 108. In accordance with an exemplary embodiment, lubricating material 8 is preferably applied so as to form a thin film 16 on substrate surface 8 and so as to be contained within plurality of valleys 10. Once lubricating material 6 has been applied to substrate surface 8, substrate 2 is then disposed so as to be associated with mating structure 4 as shown in step 110. In accordance with an exemplary embodiment, mating structure 4 is preferably disposed relative to substrate 2 such that lubricating material 6 is disposed between substrate surface 8 and mating surface 14.

In accordance with an exemplary embodiment, lubricating material 6 is preferably adhesively bonded to substrate 2 and is preferably mechanically retained to substrate 2 via the nature of the plurality of valleys 10 formed in substrate surface 8 which traps or retains lubricating material 6 within valleys 10. When a high load is applied by mating surface 14 onto substrate surface 8, lubricating material is retained in valleys 10 so that it cannot extrude out of bearing system 1. This advantageously prevents lubricating material 6 from migrating out of the wear zone when thin self-lubricating film/metallic bearing system 1 is exposed to high loads or vibration.

In accordance with an exemplary embodiment, the combination of material used to construct substrate 2, the processing of substrate 2 so as to roughen substrate surface 8 and the use of a solid film of lubricating material 6 advantageously combine to form a failsafe bearing system. When the bearing has worn through the thin self-lubricating film thickness a, there is residual lubricating material 6 contained in valleys 10. In addition, the unique properties of lubricating material 6 advantageously allows lubricating material 6 to work in combination with the bearing properties of the material used to construct substrate 2.

In accordance with an exemplary embodiment, as thin self-lubricating film/metallic bearing system 1 operates, the thin film of lubricating material 6 will wear until the plateaus 12 of substrate 2 are in contact with mating surface 4. The lubricating material 6 contained within valleys 10 will then advantageously migrate so as to maintain a thin film of lubricating material 6 between plateaus 12 and mating surface 4. This advantageously allows thin self-lubricating film/metallic bearing system 1 to have a high load capability due to the reinforcement and support of plateaus 12 of substrate 2.

In accordance with an exemplary embodiment, the shape of plateaus 12 allows substrate 2 to wear until an ideal area ratio is reached based on bearing system 1 pressure, materials, lubricant, etc. This ideal area ratio allows the bearing system 1 to reach an equilibrium point upon which the bearing will arrest further wear. The self-lubricating material is advantageously contained in valleys 10 formed by processing substrate 2. As this bearing experiences oscillations, vibrations, or micro-motion, lubricating material 6 contained within valleys 10 is continually dispersed to form a lubricant film transfer to the mating surface 14 and plateaus 12 of substrate 2. This unique type of construction advantageously prevents the escape of particles of lubricating material 6 from the wear zone as the valleys 10 act to catch, retain and re-apply lubricating material 6 to plateaus 12 of substrate 2 as the bearing system 1 oscillates and/or rotates.

In accordance with an exemplary embodiment, mating structure 8 may be an integral component of bearing system 1, such as a spherical ball is a spherical bearing, and/or mating structure 8 may be a separate component, such as a shaft which is inserted into a bushing and thus becomes mating structure 8.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A thin self-lubricating film bearing system comprising:
a mating structure having a mating surface;
a substrate, wherein said substrate includes a substrate surface having a plurality of valleys, wherein said substrate is disposed so as to communicate said mating surface with said substrate surface; and
a lubricating material, wherein said lubricating material is disposed relative to said substrate so as to be communicated with said substrate surface and said mating surface.

2. The system according to claim 1, wherein said mating structure is constructed of metal.

3. The system according to claim 1, wherein said mating structure is constructed of metal having a plating/plasma spray/HVOF coating.

4. The system according to claim 1, wherein said substrate is constructed of a metallic material having corrosion resistant properties.

5. The system according to claim 1, wherein said lubricating material is constructed of polymer resin.

6. The system according to claim 1, wherein said lubricating material is constructed of Teflon®.

7. The system according to claim 1, wherein said lubricating material is constructed of PTFE material.

8. The system according to claim 1, wherein said lubricating material is constructed of a graphite material.

9. The system according to claim 1, wherein said lubricating material is capable of operating in thermal environments from about −200° F. to about +700° F.

10. The system according to clam 1, wherein said lubricating material is disposed so as to form a material film on said substrate surface having a film thickness, a.

11. The system according to claim 10, wherein said film thickness a is between about 0.001 inches thick and about 0.005 inches thick.

12. The system according to claim 1, wherein said lubricating material is disposed relative to said substrate so as to be disposed within said plurality of valleys.

13. The system according to claim 1, wherein said lubricating material is disposed so as to be between said substrate surface and said mating surface.

14. A method for implementing a self-lubricating film bearing system comprising:
obtaining a lubricating material and a substrate, wherein said substrate includes a substrate surface;
processing said substrate surface so as to create a plurality of valleys within said substrate surface;
cleaning said substrate surface so as to remove impurities from said substrate surface;
applying said lubricating material to said substrate surface so as to dispose a thin film of said lubricating material on said substrate surface; and
associating said substrate with a mating structure having a mating surface, wherein said mating structure is disposed relative to said substrate such that said lubricating material is disposed between said substrate surface and said mating surface.

15. The method according to claim 14, wherein said processing includes roughening said substrate surface via grit blasting.

16. The method according to claim 14, wherein said processing includes roughening said substrate surface via a knurling process.

17. The method according to claim 14, wherein said processing includes roughening said substrate surface via chemical etching.
